(19) United States
(12) Patent Application Publication
(10) Pub. No.: US 2010/0214058 A1
(43) Pub. Date: Aug. 26, 2010

(54) SECURITY ACCESS METHOD AND SYSTEM

(75) Inventor: Brian A. WALKER, San Francisco, CA (US)

Correspondence Address: Visa USA c/o Duane Morris LLP;Attn: James Sze, Esq., 101 West Broadway, Suite 900, San Diego, CA, 92101, US

(73) Assignee: Visa U.S.A. Inc., San Francisco, CA (US)

(21) Appl. No.: 12/391,830

(22) Filed: Feb. 24, 2009

(51) Int. Cl. G05B 19/00

(52) U.S. Cl. 340/5.6; 340/5.7

(57) ABSTRACT

A method includes transmitting a request for authorization to enter a physical space over a payment processing network that processes financial transactions. The financial transactions are transmitted between an acquirer institution and an issuing institution via the payment processing network. A response is received, granting or denying authorization to enter the physical space from the payment processing network.

### CROSS-REFERENCE TO RELATIONS APPLICATIONS

NONE

### FIELD OF THE INVENTION

Aspects of the present disclosure relate to security systems and methods.

### BACKGROUND

Most large businesses, institutions and government facilities have implemented physical security measures to limit ingress to and egress from restricted areas to authorized personnel. Many of these systems require presentation of a machine readable medium or device, such as a badge, magnetically encoded card, radio frequency (RF) tag, or the like.

Upon presentation of the medium or device, a query is made to a security database, to determine whether the person presenting the medium or device is authorized to enter the area. In some organizations, each facility has its own standalone database, so that visiting personnel from another facility of the same organization are not recognized outside of their home facility. Other organizations have networked systems employing proprietary wide area networks (WANs) to enable regional offices to maintain copies of all employee records.

Improved security solutions are desired.

### SUMMARY

In some embodiments, a method comprises transmitting a request for authorization to enter or leave a physical space over a payment processing network that processes financial transactions, which are transmitted between an acquirer institution and an issuing institution via the payment processing network. A response is received, granting or denying authorization to enter or leave the physical space from the payment processing network.

In some embodiments, a method comprises receiving an electronic request for authorization to enter or leave a physical space via a payment processing network that processes financial transactions, which are transmitted between an acquirer institution and an issuing institution via the payment processing network. A security database is queried to determine whether a person making the request is permitted to enter or leave the physical space. An electronic response is transmitted granting or denying authorization to enter or leave the physical space over the payment processing network, the response being based on a result of the querying.

In some embodiments, a method comprises processing financial transactions that are transmitted between an acquirer institution and an issuing institution using a payment processing network communications protocol and a payment processing network message format. An electronic request is received for authorization to enter or leave a physical space from a terminal configured to read a payment processing device. The electronic request is formatted according to the payment processing network message format. The electronic request is transmitted to an entity that is responsible for defining access permission to the physical space, using the payment processing network communications protocol.

In some embodiments, a machine readable storage medium is encoded with computer program code such that, when the computer program code is executed by a processor, the processor performs a method, comprising transmitting a request for authorization to enter or leave a physical space over a payment processing network that processes financial transactions. The financial transactions are transmitted between an acquirer institution and an issuing institution via the payment processing network. A response is received for granting or denying authorization to enter or leave the physical space from the payment processing network.

In some embodiments, a machine readable storage medium is encoded with computer program code such that, when the computer program code is executed by a processor, the processor performs a method, comprising: receiving an electronic request for authorization to enter or leave a physical space via a payment processing network that processes financial transactions, the financial transactions transmitted between an acquirer institution and an issuing institution via the payment processing network; querying a security database to determine whether a person making the request is permitted to enter or leave the physical space; and transmitting an electronic response granting or denying authorization to enter the physical space over the payment processing network, the response being based on a result of the querying.

In some embodiments, a terminal is configured for transmitting a request for authorization to enter or leave a physical space over a payment processing network that processes financial transactions, the financial transactions being transmitted between an acquirer institution and an issuing institution via the payment processing network. The terminal is configured for receiving a response granting or denying authorization to enter or leave the physical space from the payment processing network.

In some embodiments, a system comprises a processor, coupled to a payment processing network that processes financial transactions transmitted between an acquirer institution and an issuing institution via the payment processing network. The processor is configured for receiving, via the payment processing network, a request for authorization to enter or leave a physical space. A machine readable storage medium is accessible by the processor. The machine readable storage medium contains a security database that includes data identifying whether a person initiating the request is permitted to enter or leave the physical space. The processor is configured for transmitting an electronic response granting or denying authorization to enter the physical space over the payment processing network. The response is based on a result of the data in the security database.

### BRIEF DESCRIPTION OF THE DRAWINGS

FIG. 1 is a block diagram of a system according to one embodiment.

FIG. 2 is a flow chart of a method performed by one of the terminals in FIG. 1.

FIG. 3 is a flow chart of a method performed by one of the issuers in FIG. 1.

FIG. 4 is a flow chart of a method performed by the payment processing network in FIG. 1.

FIG. 5 is a diagram showing a data format of an authorization request or authorization response message.

FIG. 6 is a detailed block diagram of one of the terminals of FIG. 1.

FIG. 7 is a detailed block diagram of one of the badge issuing employer computers of FIG. 1.

### DETAILED DESCRIPTION

This description of embodiments is intended to be read in connection with the accompanying drawings, which are to be considered part of the entire written description.

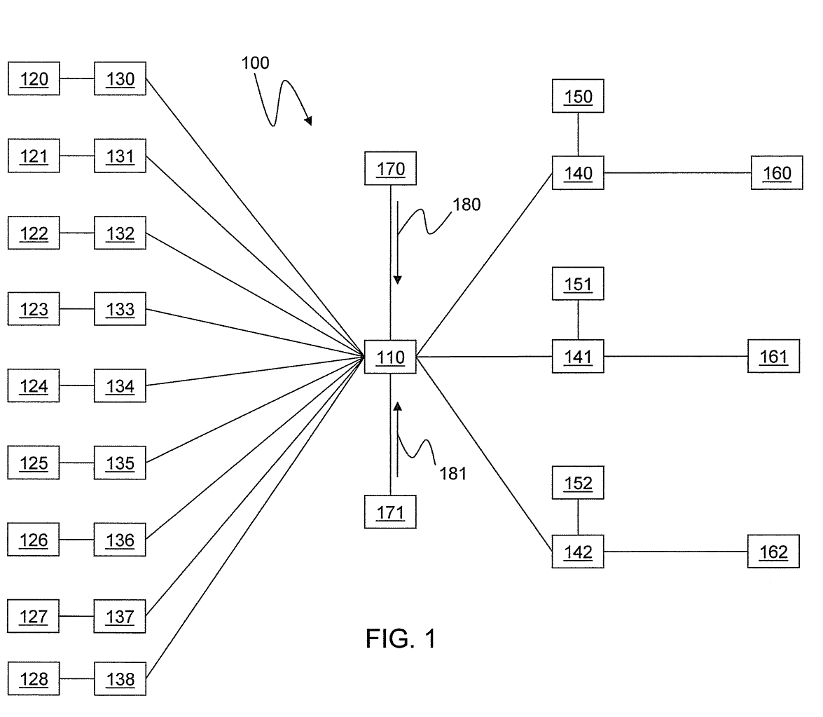

FIG. 1 shows an example of a system 100 in which security access requests and authorizations for access to enter or leave a physical space are transmitted over a payment processing network 110. The authorizations requests are sent from a plurality of terminals 130-138 via PPN 110 to one or more “badge issuing employers” 140-142, which may be private companies or government entities, for example. The issuing employer institutions 140-142 determine whether to permit access, and send “grant” or “deny” responses to the respective terminals 130-138 from which the requests originate.

The system 100 is used to control access to a variety of types of physical spaces, including a campus 120, a building 122, a wing 123, a floor 124, a room 125, or a parking lot (not shown). In some embodiments, the system 100 initiates automated opening of an access device at the entrance to the physical space. Examples of such access devices include, but are not limited to, a door 128, a gate 121, a turnstile 126 or a mantrap 127. These are only intended as examples, and do not limit the types of physical spaces or access control devices.

The PPN 110 may be an authorization, clearing and settling network that is used by merchants to obtain rapid authorization of point of sale (POS) purchases, and used by credit card acquirers 170 that provide acceptance services to the merchants, and used for settlement transactions with the credit card issuer institutions 171 that issue the credit cards to the customer. An example of such a PPN is the “VISANE™” global clearing and settlement system provided by Visa, Inc. of Foster City, Calif.

The financial transactions 180, 181 may be point of sale purchases. For example, message 180 may be an authorization request for a point of sale purchase, and message 181 may be an authorization response corresponding to that authorization request 180. A typical financial transaction using the PPN 110 involves the following events (although this is only an example, and does not limit the activities performed by PPN 110).

A cardholder presents a merchant with a debit or credit card, or other type of payment device (e.g., payroll card, rechargeable prepaid card, radio frequency identification (RFID) tag, cell phone, smart phone or a personal digital assistant), for payment. A merchant point-of-sale terminal (not shown) reads the account number and other data encoded on the card's magnetic stripe or chip. The merchant terminal transmits the card information and transaction amount to the acquirer 170 (the authorization request 180). The acquiring bank 170 or its third-party processor combines the transaction information into an authorization request message 180 and transmits it to the PPN 110. The PPN 110 routes the authorization request 180 to the issuer 171 for review. The issuing bank 171 or its third-party processor sends an authorization response 181 message to the PPN 110, either approving or denying the transaction. The PPN 110 routes the authorization response 181 to the acquirer 170. The acquirer 170 transmits the result of the authorization request to the merchant terminal.

In the example of FIG. 1, the same architecture that is used for financial transaction authorization can be used to process authorization requests and responses for physical access to a secured area. The PPN 110 processes and delivers the access authorization requests using the same communications infrastructure (wired and/or wireless transmission media, processors and routers) and communications protocol used for transmitting the financial transaction messages 180, 181.

A plurality of terminals 130-138 are provided for the security authorization transactions. Although FIG. 1 only shows nine terminals 130-138, any number of terminals may be provided. Each terminal 130-138 is configured for transmitting a request for authorization to enter or leave a physical space over the payment processing network (PPN) 110 that processes financial transactions 180, 181. The terminals 130-138 are also configured for receiving a response granting or denying authorization to enter or leave the physical space from the payment processing network.

Although the financial transactions 180, 181 are transmitted between a processor 170 at an acquirer institution and a processor 171 at an issuing institution, the security access authorization requests and responses are transmitted between entrances/exits/access control devices of secured physical spaces and the security database of the entities controlling those spaces (e.g., corporations and government entities). In some cases, the secured physical spaces may be facilities of acquirer banks 170 or credit card issuing banks 171, but this is not a requirement.

For brevity, hereafter, the processor 170 of the acquirer institution is referred to as the acquirer 170, and the processor 171 of the issuer institution is referred to as the issuer 171.

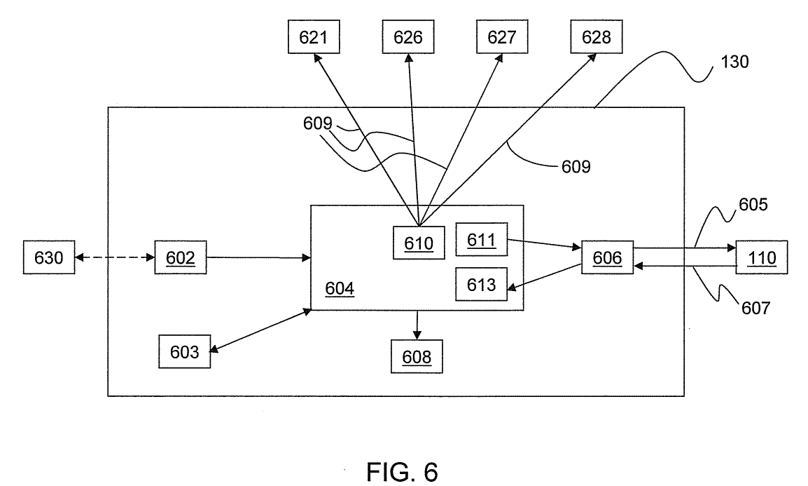

FIG. 6 is a block diagram of terminal 130, which is an example of one of the terminals. Terminals 131-138 may be configured similarly. Terminal 130 is equipped with a reading device 602 having a sensor capable of extracting data from a badge, payment device or identification device 630 that is positioned adjacent the reading device. For example, the reading device 602 may be a magnetic stripe reader, an RFID tag reader, an optical bar code scanner, or a near field communication reader, such as those made by NTT docomo, Inc. of Tokyo, Japan, or the like. The reading device 602 may be of a contact type or non-contact type. In some embodiments, the data are stored in a storage medium on or in an employee badge adapted to be worn by the user. The storage medium may be a magnetic stripe, RFID tag, optical bar code, integrated circuit, or the like.

Terminal 130 has a processor 604 in communication with the reading device 602. The processor 604 includes means 611 for generating the access authorization request 605 upon presentation of an employee badge or payment device adjacent to a terminal. The processor 604 also includes means 613 for receiving the access authorization response.

Terminal 130 is further equipped with a communications interface 606 coupled directly or indirectly to the PPN 110. The communications interface 606 may be wired or wireless, and conforms to the hardware layer, link layer and network layer interface protocols of the PPN 110. The request 605 for authorization to enter or leave the physical space and the response 607 granting or denying authorization to enter or leave the physical space are transmitted using a communication protocol and message format that are used for financial transactions.

Terminal 130 has a display 608 for outputting instructions, the results of the access authorization requests, and optionally, the status of any pending access authorization request.

The terminal 130 further comprises means 610 responsive to the access authorization response 607 for transmitting a signal 609 to initiate opening of an access control device 621, 626, 627, 628 upon receiving a response 607 granting authorization to enter or leave the physical space. The access control device may be, for example, a door 628, gate 621, a turnstile 626, or a mantrap 627. Other types of access control devices may also be activated automatically by the transmitting means 610 upon receipt of a response 607 granting access to the space.

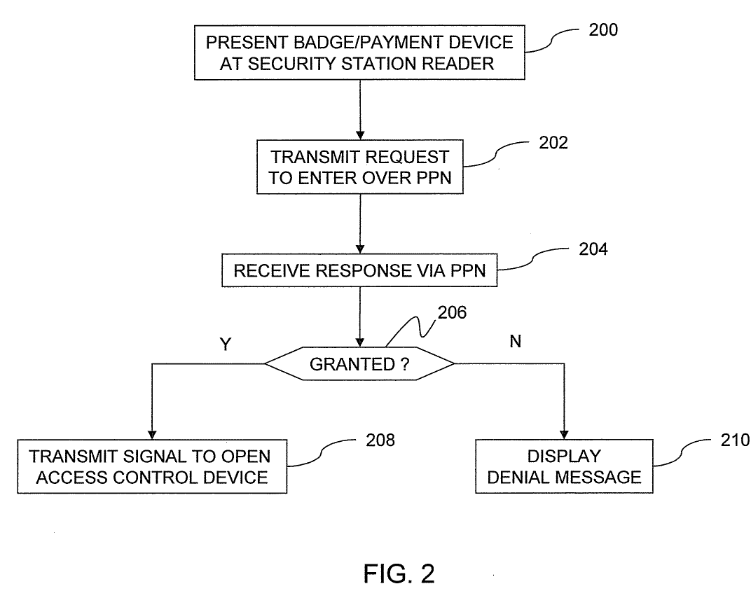

The terminal 130 has a machine readable storage medium 603, which may include one or more of memory, magnetic or optical disc storage or the like. The machine readable storage medium 603 is encoded with computer program code. When the processor 604 executes the computer program code stored in medium 603, the processor performs a method described below with reference to FIG. 2.

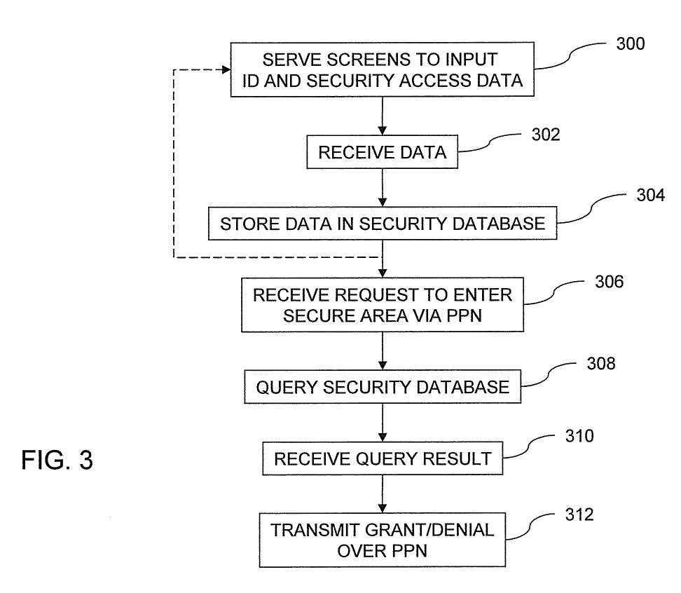

Referring again to FIG. 1, a plurality of badge issuing employer computers 140-142 are shown. It will be understood that the blocks 140-142 represent computer systems operated by the badge issuing employers, and not the employer personnel themselves. The badge issuing employer computers 140-142 may include communications front end equipment (not shown) for interfacing to the PPN 110. Each badge issuing employer computer 140-142 has a respective computer readable storage medium 150-152 (e.g., magnetic or optical disc drive, or solid state memory device) which stores a security database. Each badge issuing employer computer 140-142 has a respective terminal or computer 160-161 specially programmed with a graphical user interface (GUI). Security operations personnel can enter and maintain the data in the security database via the GUI 160-161. Each badge issuing employer computer 140-142 has a machine readable storage medium, which may include one or more of memory, magnetic or optical disc storage or the like. The machine readable storage media of computers 140-142 are encoded with computer program code. When the computer 140-142 executes the computer program code stored in its storage medium, the computer performs a method described below with reference to FIG. 3.

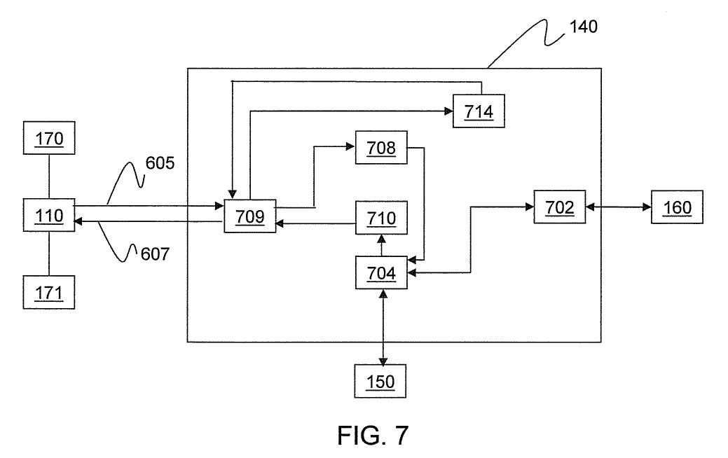

FIG. 7 is a block diagram of an example of one of the badge issuing employer's computers 140. The external interface to PPN 110 (which processes financial transactions between acquirer 170 and issuer 171) is described above, and for brevity, the description is not repeated.

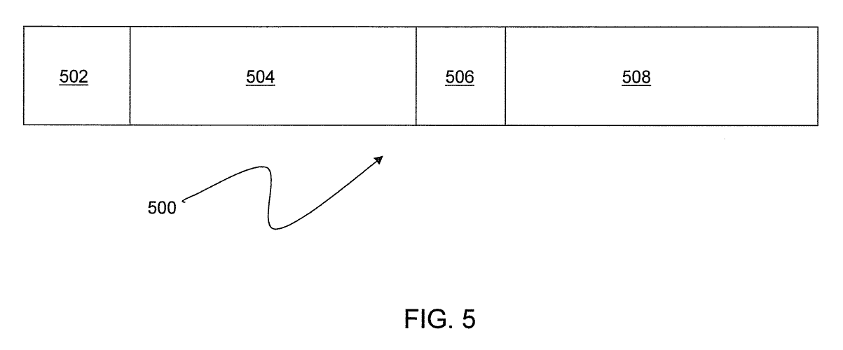

The computer 140 has a financial transaction application 714, coupled to PPN 110 that processes financial transactions transmitted between an acquirer institution 170 and an issuing institution 171 via the PPN 110. A message processing layer or module 709 is configured for receiving, via the PPN 110, a request for authorization to enter or leave a physical space. The message processing layer or module 709 inspects the transaction-type field 506 (shown in FIG. 5) of an incoming message from PPN 110 and determines whether the transaction is a financial transaction or an access authorization request. Financial transactions are passed to the financial processing application 714, and access authorization requests are passed to the security access request processing module 708. In some cases, the badge issuing institution is not a financial institution, and does not process financial transactions, in which case, the issuing institution does not include the financial processing application 714.

Referring again to FIG. 7, the badge issuing employer's computer 140 has a database management system (DBMS) 704, which controls the indexing and storage of the security database, accepts queries and outputs query results.

A machine readable storage medium 150 is accessible by the DBMS 704 in processor 140. The machine readable storage medium 150 contains the security database that includes data identifying whether a person initiating the request is permitted to enter or leave the physical space.

The processor 140 is configured with a module 710 for generating an electronic response granting or denying authorization to enter or leave the physical space over the PPN 110. The response is based on a result of the data in the security database 150. The response is transmitted back to PPN 110 by the message processing layer or module 709.

The message processing layer or module 709 accepts authorization response messages in a format generated by the security DBMS and performs any of the following to output the message according to the protocol and format used by the PPN:

(1) Inserting the header 502 according to the header format used for financial transactions at the beginning of the message;

(2) inserting dummy (pad) data to fill out any field 504 or 508 of the financial transaction message 500 according to the prescribed length of that field; and

(3) setting the transaction type field 506 to a value corresponding to physical space access authorization request or response.

The message interface layer may also accept the authorization requests from PPN 110 and reformat the message according to the protocol and format used by the badge issuing employer computers 140-142.

In some embodiments, the security DBMS used by the badge issuing employer computers 140-142 generates and accepts messages in the format used by the PPN 110, then the message processing layer or module 709 may be omitted. For example, in some embodiments, the provider of the PPN 110 provides a compatible security database to the badge issuing employers for use on computers 140-142.

Referring again to FIG. 7, the processor 140 includes means 702 for serving graphical user interface screens to a client processor 160 for use by an administrator. The user interface screens prompt the administrator to enter data defining the areas to which each authorized person has permission to enter. The GUI serving means 702 include an application for serving a screen, receiving input data from the administrator, and forwarding the data input by the administrator to DBMS 704 for storage in the database 150. These data are generally entered a priori by the administrator, and updated as new employees are hired and existing employees have a need to visit additional areas.

At the time an access authorization request message 605 is received, the DBMS 704 queries the database in medium 150 for the record associated with the holder of the badge or payment device presented at the terminal 130, and identifies whether the person making the request is permitted to enter or leave the physical space.

FIG. 2 is a flow chart of a method of requesting and receiving a physical access authorization.

At block 200, a person seeking physical access to a space presents a badge or a payment device at a terminal 130-138. The terminal has a sensor and the badge has a storage medium storing information readable by the terminal. The payment device may be a credit card, debit card, payroll card, rechargeable prepaid card, radio frequency identification tag, cell phone, smart phone or a personal digital assistant, for example. The presenting event may include swiping a magnetic strip over a reader, passing an RF ID token over a sensor, passing a bar code over a reader, or the like.

The terminal 130-138 automatically generates a request 605 for physical access upon presentation of the employee badge or payment device adjacent to the terminal.

At block 202, the terminal 130-138 transmits a request 605 to enter or leave the physical space via the PPN 110 that processes financial transactions, using the same protocol and message format used by acquirer institutions 170 for financial transactions, Typically, financial transactions are transmitted between the acquirer institution 170 and an issuing institution 171 via the payment processing network 110. However, in block 202, the request for physical access authorization is sent to the processor (e.g., 140, 141, 142) hosting the DBMS 704 for the organization that controls access authorizations to the physical space.

At block 204, the terminal 130-138 receives a response 607 from the processor (e.g., 140, 141, 142) hosting the DBMS 704 for the organization that controls access authorizations to the physical space. The response 607 grants or denies authorization to enter or leave the physical space from the PPN 110. The response 607 granting or denying authorization to enter or leave the physical space is received using the same communication protocol and message format that are used for financial transactions.

At block 206, if the request 605 is granted, block 208 is executed. If the request is denied, block 210 is executed.

At block 208, the terminal 130 transmits a signal initiating opening of the access control device (e.g., gate, door, turnstile or the like). In some embodiments, instead of opening a gate, door, turnstile, or mantrap, an approval message is displayed and/or an audible signal is generated.

At block 210, a denial message is displayed and/or auditory signal generated, indicating that the requested access is denied.

FIG. 3 is a flow chart of a method performed by a computer operated by an entity responsible for controlling access authorizations to the physical space. For example, if the physical space is a building or room in a corporate campus, the corporation operating that space typically has a security operation or department responsible for controlling access to the physical space. The security operation or department may have a security database (e.g., 150, 151 or 152 in FIG. 1) identifying employees, their projects, their security clearance (if any), their normal work area, and additional areas they may be authorized to enter. The security database (150, 151 or 152) is stored in a computer readable storage medium of a computer system (140, 141, or 142). The computer system includes a database management system (DBMS) 704. The DBMS may be a commercially available security database system, a commercially available relational DBMS, or a custom DBMS. Because each entity stores its own security data in its own database, there is no need to store a master security database containing all of the security information on PPN 110.

At block 300, the security DBMS serves screens to the GUI on the administrator's terminal or computer with instructions for inputting identification and security access data for employees, visitors, or others who will be given access to the controlled access physical space. Input fields are displayed, into which the user enters the requested data. In addition to the person's name, identification and security access data, a record for an individual employee/visitor may also include identification of acceptable alternative form factors that the individual may use to request and receive access. For example, the individual may be authorized to present a designated picture credit card or other designated type of payment device if the individual forgets his or her badge. (The types of form factors to be accepted by the system may be entered in a separate administrative interface screen, and may include global defaults and/or specific form factors to be accepted for each respective physical space.).

At block 302, the administrator enters the data into the badge issuing employer's computer 140-142 using the respective GUI 160-162. The entered data define the authorized physical spaces and acceptable access devices (badge and/or payment device) for a given employee or visitor.

At block 304, the received data are stored in the record of the security database associated with a given employee.

Blocks 300-304 may be repeated as often as desired to enter and update the database record associated with each person having access to any of the physical spaces controlled by the system.

At block 306, one of the badge issuing employers' computers 140-142 receives an electronic request 605 for authorization to enter or leave a physical space via a payment processing network that processes financial transactions, which are transmitted between an acquirer institution and an issuing institution via the same payment processing network. Block 306 is performed asynchronously from blocks 300-304.

At block 308, the badge issuing employer's computer 140-142 queries its respective security database 150-152 to determine whether the person making the request is permitted to enter or leave the physical space.

At block 310, the security database returns information identifying whether the requesting person is authorized to enter or leave the physical space for which access was requested.

At block 312, the badge issuing employer's computer 140-142 transmits an electronic response 607 granting or denying authorization to enter or leave the physical space over the PPN 110. The response 607 is based on a result of the querying. The response 607 granting or denying authorization to enter or leave the physical space is transmitted using the same communication protocol and message format that are used for financial transactions.

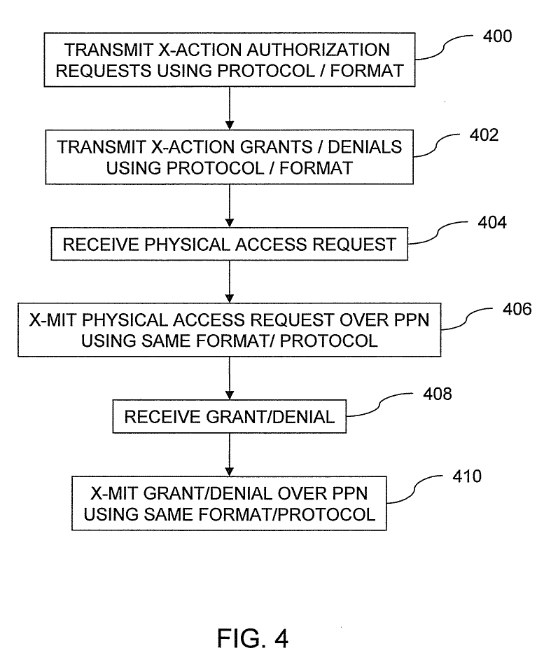

FIG. 4 is a flow chart of a process performed by PPN 110.

At block 400, PPN 110 receives transaction authorization requests from acquirer banks 170 and transmits each respective request to the respective issuer bank 171 of the cardholder. The transactions for which authorization is requested by be credit, debit, or prepaid card transactions, for example. The transactions use the PPN's prescribed communications protocol and a payment processing network message format.

At block 402, PPN 110 receives transaction authorization responses (grants and/or denials) from issuer banks 171 of each cardholder requesting a transaction authorization, and PPN 110 transmits each respective response to the respective acquirer bank from which the respective transaction authorization request was received. The transaction responses use the PPN's prescribed communications protocol and a payment processing network message format.

At block 404, PPN 110 receives an electronic request for authorization to enter or leave a physical space from a terminal configured to read a payment processing device. The electronic request is formatted according to the same PPN message protocol and format used in block 400. In some cases, PPN 110 may receive the request directly from a terminal 130-138. In other cases, PPN 110 may receive the request by way of an acquirer bank that provides a gateway for transmitting the request to the PPN 110.

At block 406, PPN 110 transmits the electronic request to the computer 140-142 of the entity responsible for defining access permission for the particular physical space to which access was requested. The message is transmitted according to the same PPN message protocol and format used in block 400.

At block 408, PPN 110 receives an electronic response from the computer 140-142 of the responsible entity granting or denying authorization to enter or leave the physical space. The electronic response is formatted according to a second PPN message format that is used for the financial transactions in block 402.

At block 410, PPN 110 transmits the electronic response over the payment processing network to the terminal, using the PPN communications protocol.

In the example of FIG. 4, the acquirer 170, issuer 180, terminal 130 and badge issuer 140 are four separate nodes. In some cases, one or more of these nodes may be owned and operated by a single entity (e.g., corporation or government agency). For example, the badge issuer computer 140 and terminal 130 may be owned and operated by an acquirer bank or a credit-card issuing bank.

In some cases, a single entity may a request of one type of transaction (financial or access) and a response of the other type of transaction. A credit-card issuing bank may be the recipient of financial transaction authorization requests from the PPN 110 and the sender of physical access authorization requests to the PPN. An acquirer bank may be the sender of financial transaction authorization requests to the PPN and the recipient of physical access authorization requests from the PPN.

FIG. 5 is a diagram of the format of the request 500 for authorization to enter or leave a physical space. The request 500 has a header 502, and a plurality of prescribed message fields 504, 506 and 508 which carry prescribed data types in prescribed formats for financial transactions. In particular, the request 500 for authorization to enter or leave a physical space includes a physical-access-request transaction code 506 in a transaction-type field position that is used to identify a type of financial transaction in a financial services authorization request.

Although examples described above use the system and method to control access to or egress from a space, the method and apparatus may also be used to record attendance at meetings or the like.

Although the invention has been described in terms of examples and embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method, comprising:
transmitting a request for authorization to enter or leave a physical space over a payment processing network that processes financial transactions, the financial transactions being transmitted between an acquirer institution and an issuing institution via the payment processing network; and
receiving a response granting or denying authorization to enter or leave the physical space from the payment processing network.

2. The method of claim 1, further comprising automatically generating the request upon presentation of an employee badge adjacent to a terminal, wherein the terminal has a sensor and the badge has a medium storing information readable by the terminal.

3. The method of claim 1, further comprising automatically generating the request upon presentation of a payment device adjacent to a terminal, wherein the terminal has a sensor and the badge has a medium storing information readable by the terminal.

4. The method of claim 3, wherein the payment device is one of the group consisting of a credit card, debit card, payroll card, rechargeable prepaid card, radio frequency identification tag, cell phone, smart phone and a personal digital assistant.

5. The method of claim 1, wherein the request for authorization to enter or leave the physical space and the response granting or denying authorization to enter or leave the physical space are transmitted using a communication protocol and message format that are used for financial transactions.

6. The method of claim 1, further comprising transmitting a signal to initiate opening of an access control device upon receiving a response granting authorization to enter or leave the physical space, the access control device being one of the group consisting of a gate, a turnstile, or a mantrap.

7. The method of claim 1, wherein the request for authorization to enter or leave a physical space includes a physical-access-request transaction code in a transaction-type field position that is used to identify a type of financial transaction in a financial services authorization request.

8. A method, comprising:
receiving an electronic request for authorization to enter or leave a physical space via a payment processing network that processes financial transactions, the financial transactions transmitted between an acquirer institution and an issuing institution via the payment processing network;
querying a security database to determine whether a person making the request is permitted to enter or leave the physical space; and
transmitting an electronic response granting or denying authorization to enter or leave the physical space over the payment processing network, the response being based on a result of the querying.

9. The method of claim 8, wherein the request for authorization to enter the physical space and the response granting or denying authorization to enter the physical space are transmitted using a communication protocol and message format that are used for financial transactions.

10. The method of claim 8, wherein the request for authorization to enter a physical space includes a physical-access-request transaction code in a transaction-type field position that is used to identify a type of financial transaction in a financial services authorization request.

11. A method, comprising:
processing financial transactions that are transmitted between an acquirer institution and an issuing institution using a payment processing network communications protocol and a payment processing network message format;
receiving an electronic request for authorization to enter or leave a physical space from a terminal configured to read a payment processing device, the electronic request formatted according to the payment processing network message format; and
transmitting the electronic request to an entity that is responsible for defining access permission to the physical space, using the payment processing network communications protocol.

12. The method of claim 11, further comprising:
receiving an electronic response from the responsible entity granting or denying authorization to enter or leave the physical space, the electronic response formatted according to a second payment processing network message format that is used for the financial transactions.
transmitting the electronic response over the payment processing network to the terminal, using the payment processing network communications protocol.

13. A machine readable storage medium encoded with computer program code such that, when the computer program code is executed by a processor, the processor performs a method, comprising:
transmitting a request for authorization to enter or leave a physical space over a payment processing network that processes financial transactions, the financial transactions being transmitted between an acquirer institution and an issuing institution via the payment processing network; and
receiving a response granting or denying authorization to enter or leave the physical space from the payment processing network.

14. The machine readable storage medium of claim 13, wherein the method further comprises automatically generating the request upon presentation of an employee badge or payment device adjacent to a terminal, wherein the terminal has a sensor and the badge has a medium storing information readable by the terminal.

15. The machine readable storage medium of claim 14, wherein the payment device is one of the group consisting of a credit card, debit card, payroll card, rechargeable prepaid card, radio frequency identification tag, cell phone, smart phone and a personal digital assistant.

16. The machine readable storage medium of claim 13, wherein the request for authorization to enter or leave the physical space and the response granting or denying authorization to enter or leave the physical space are transmitted using a communication protocol and message format that are used for financial transactions.

17. The machine readable storage medium of claim 13, wherein the method further comprises transmitting a signal to initiate opening of an access control device upon receiving a response granting authorization to enter or leave the physical space, the access control device being one of the group consisting of a gate, a turnstile, or a mantrap.

18. The machine readable storage medium of claim 13, wherein the request for authorization to enter or leave a physical space includes a physical-access-request transaction code in a transaction-type field position that is used to identify a type of financial transaction in a financial services authorization request.

19. A machine readable storage medium encoded with computer program code such that, when the computer program code is executed by a processor, the processor performs a method, comprising:
receiving an electronic request for authorization to enter or leave a physical space via a payment processing network that processes financial transactions, the financial transactions transmitted between an acquirer institution and an issuing institution via the payment processing network;
querying a security database to determine whether a person making the request is permitted to enter or leave the physical space; and
transmitting an electronic response granting or denying authorization to enter or leave the physical space over the payment processing network, the response being based on a result of the querying.

20. The machine readable storage medium of claim 19, wherein the request for authorization to enter or leave the physical space and the response granting or denying authorization to enter or leave the physical space are transmitted using a communication protocol and message format that are used for financial transactions.

21. The machine readable storage medium of claim 19, wherein the request for authorization to enter or leave a physical space includes a physical-access-request transaction code in a transaction-type field position that is used to identify a type of financial transaction in a financial services authorization request.

22. A terminal,
the terminal configured for transmitting a request for authorization to enter a physical space over a payment processing network that processes financial transactions, the financial transactions being transmitted between an acquirer institution and an issuing institution via the payment processing network; and
the terminal configured for receiving a response granting or denying authorization to enter or leave the physical space from the payment processing network.

23. The terminal of claim 22, wherein the terminal includes means for generating the request upon presentation of an employee badge or payment device adjacent to a terminal, wherein the terminal has a sensor and the badge has a medium storing information readable by the terminal.

24. The terminal of claim 23, wherein the terminal has a reader capable of reading at least one of the group consisting of a payment device from the group consisting of a credit card, debit card, payroll card, rechargeable prepaid card, radio frequency identification tag, cell phone, smart phone and a personal digital assistant.

25. The terminal of claim 22, wherein the request for authorization to enter or leave the physical space and the response granting or denying authorization to enter the physical space are transmitted using a communication protocol and message format that are used for financial transactions.

26. The terminal of claim 22, wherein the terminal further comprises means for transmitting a signal to initiate opening of an access control device upon receiving a response granting authorization to enter or leave the physical space, the access control device being one of the group consisting of a gate, a turnstile, or a mantrap.

27. A system comprising:
a processor, coupled to a payment processing network that processes financial transactions transmitted between an acquirer institution and an issuing institution via the payment processing network, the processor configured for receiving, via the payment processing network, a request for authorization to enter a physical space;
a machine readable storage medium accessible by the processor, the machine readable storage medium containing a security database that includes data identifying whether a person initiating the request is permitted to enter or leave the physical space; and
the processor configured for transmitting an electronic response granting or denying authorization to enter or leave the physical space over the payment processing network, the response being based on a result of the data in the security database.

28. The system of claim 27, further comprising means for serving user interface screens to a client, the user interface screens querying an administrator to enter the data identifying whether the person making the request is permitted to enter or leave the physical space.

29. The system of claim 27, wherein the request for authorization to enter or leave the physical space and the response granting or denying authorization to enter or leave the physical space are transmitted using a communication protocol and message format that are used for financial transactions.

30. The system of claim 27, wherein the request for authorization to enter or leave a physical space includes a physical-access-request transaction code in a transaction-type field position that is used to identify a type of financial transaction in a financial services authorization request.
